(19) United States
(12) Patent Application Publication
(10) Pub. No.: US 2009/0114499 A1
(43) Pub. Date: May 7, 2009

(54) MAGNETIC CLUTCH PULLEY

(76) Inventor: Ik Jae Maeng, Incheon (KR)

Correspondence Address: IPLA P.A., 3580 WILSHIRE BLVD., 17TH FLOOR, LOS ANGELES, CA, 90010, US

(21) Appl. No.: 12/302,209

(22) PCT Filed: May 10, 2007
(86) PCT No.: PCT/KR07/02290

§ 371 Date: Nov. 24, 2008

(30) Foreign Application Priority Data
May 25, 2006 (KR) 10-2006-0047138
May 10, 2007 (KR) PCT/KR2007/002290

(51) Int. Cl. F16D 27/12

(52) U.S. Cl. 192/84.961

(57) ABSTRACT

The present invention is a magnetic clutch pulley, in which the welding deformation and the occurrence of beads can be reduced, thereby maintaining rotation balance. The invention includes: a hollowed housing 30 having belt grooves 31 formed on an outer circumferential surface thereof; and a rotor 32 provided with a disk 33 inserted into the housing 30 to form a space in which a field coil body 36 can be mounted and having a plurality of circular arc slots 34 formed along the same circumference of the disk 33, wherein the housing 30 and the rotor 32 are positioned on a concentric circle of the disk 33, and a plurality of connecting projections 35 are formed along a circumference of the disk 33 to be coupled to the housing 30.

### TECHNICAL FIELD

1. Field of the Invention

The present invention relates to a magnetic clutch pulley, and more particularly to a magnetic clutch pulley, wherein, when welding a disk having circular arc slots formed therein to a housing, welded portions of the disk are minimized, so that the welding deformation and the occurrence of beads can be reduced, thereby maintaining rotation balance.

2. Background of the Invention

In general, a compressor of a vehicular air conditioner is connected to an engine and a belt to be driven. The compressor is driven by the power of the engine intermittently transmitted by a magnetic clutch such that the compressor can operate and stop as necessary. FIG. 1 illustrates a sectional view of a conventional magnetic clutch pulley. As shown in FIG. 1, the magnetic clutch pulley includes a hollowed housing 10 having belt grooves 11 formed on an outer circumferential surface thereof; a disk 13 inserted into the interior of the housing 10 and having a plurality of circular arc slots 14 formed therein; and a rotor 12 attached to the disk 13 at an end thereof. The disk 13 is welded to the housing 10 such that the housing 10 and the rotor 12 are coupled while being positioned on the same axle. More precisely, the external diameter of the disk 13 is formed to be larger than the housing 10, and welding is performed along a circumferential surface of the disk 13 coming into contact with the housing 10.

In the aforementioned configuration, bearings are rotatably inserted into a hollow portion of the rotor 12. A field coil body 15 is coupled between the housing 10 and the rotor 12 such that a clutch hub positioned outside the disk 13 is adhered or spaced apart in accordance with an intermittent operation of the field coil body 15. Therefore, the compressor is driven and stopped. The circular arc slots 14 formed in the disk 13 are formed such that a magnetic force can be smoothly transmitted by the field coil body 15 to the clutch hub positioned outside the disk 13. The circular arc slots 14 are formed through a piercing process using a press equipment.

However, since the piercing process of forming the circular arc slots 14 is very difficult when the housing 10 and the rotor 12 are formed in a body, the disk 13 is provided at the end of the rotor 12 in a body. In general, a piercing process is performed with respect to the disk 13 to form the circular arc slots 14, and the disk 13 is then welded to the housing 10. Since the deformation of the disk 13 is generated due to general welding, and the welding shape and thickness of the disk 13 are differentiated due to beads irregularly formed at welded portions 16 formed along a circumference of the disk 13, the rotation imbalance of the pulley may be caused. Therefore, noises may be generated or the pulley may be broken. If a high-priced welder is used, the beads may be considerably reduced. However, there is a disadvantage in that manufacturing costs is increased, and thus productivity is lowered.

### SUMMARY OF THE INVENTION

It is, therefore, an object of the present invention to provide a magnetic clutch pulley, wherein, when welding a disk having circular arc slots formed therein to a housing, welded portions of the disk are minimized, so that the welding deformation of the welded portions and the occurrence of beads can be reduced, thereby providing the shape of the disk in which rotation balance can be maintained, and reducing manufacturing costs required in manufacturing the disk.

According to an aspect of the present invention, there is provided a magnetic clutch pulley, which includes: a hollowed housing 30 having belt grooves 31 formed on an outer circumferential surface thereof; and a rotor 32 provided with a disk 33 inserted into the housing 30 to form a space in which a field coil body 36 can be mounted and having a plurality of circular arc slots 34 formed along the same circumference of the disk 33, wherein the housing 30 and the rotor 32 are positioned on a concentric circle of the disk 33, and a plurality of connecting projections 35 are formed along a circumference of the disk 33 to be coupled to the housing 30.

The connecting projections 35 may be welded to the housing 30, and thus circular arc slots 34 may be further formed between the housing 30 and the disk 33.

In welding the connecting projections 35 to the housing, an AC 3-phase low frequency welder provided with upper and lower electrode jigs 40 and 41 may be used, the housing 30 is fixed to the lower electrode jig 41, and the connecting projections 35 are welded and coupled to the housing 30 in a thermal insertion form by allowing a current to be flowed through the upper and lower electrode jigs 40 and 41 in the state that the upper electrode jig 40 presses the disk 33.

### BRIEF DESCRIPTION OF THE DRAWINGS

The above and other objects and features of the present invention will become apparent from the following description of preferred embodiments given in conjunction with the accompanying drawings, in which:

FIG. 1 is a sectional view of a conventional magnetic clutch pulley;

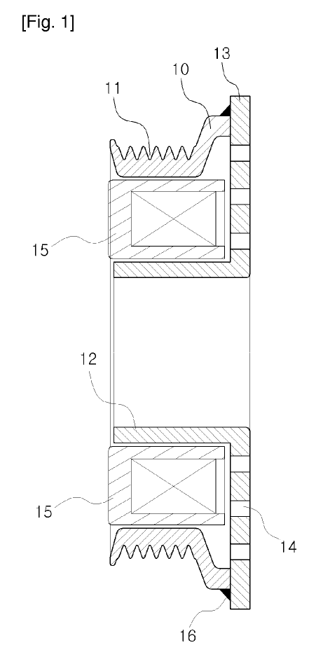

FIG. 2 is a sectional view of a magnetic clutch pulley according to an embodiment of the present invention;

FIG. 3 is a side view of the magnetic clutch pulley according to the embodiment of the present invention; and

FIG. 4 is a sectional view illustrating a process of manufacturing the magnetic clutch pulley according to the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art.

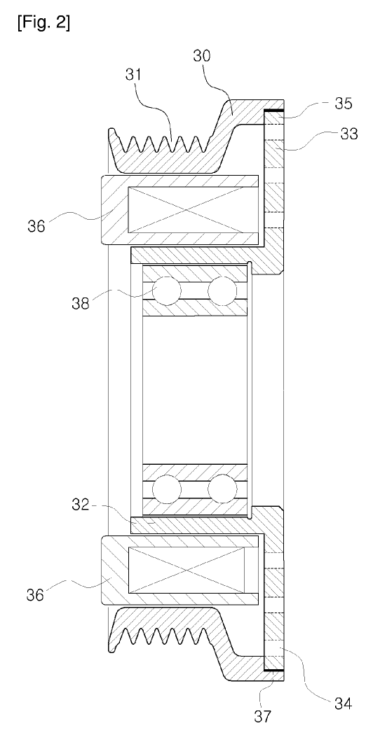

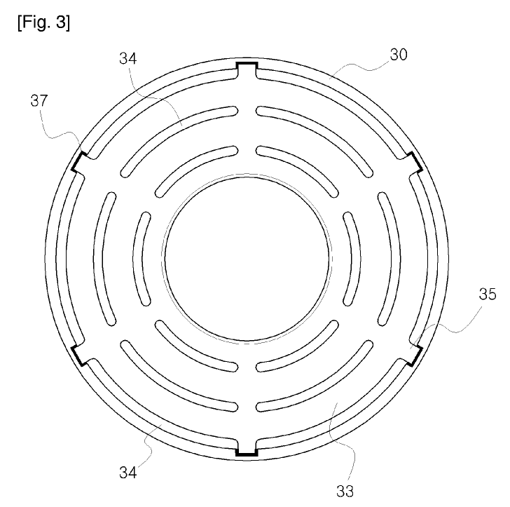

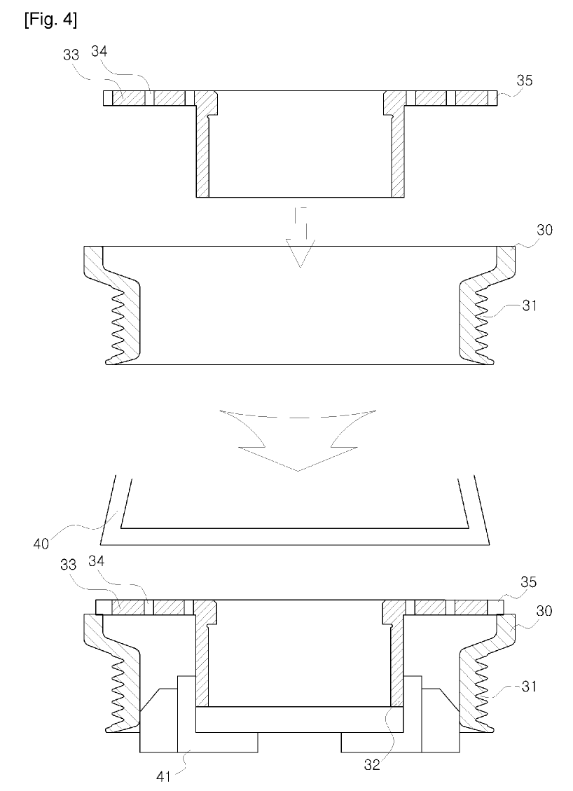

FIG. 2 is a sectional view of a magnetic clutch pulley according to a preferred embodiment of the present invention, and FIG. 3 is a side view of the magnetic clutch pulley. FIG. 4 is a sectional view illustrating a process of manufacturing the magnetic clutch pulley according to the present invention. As shown in FIG. 2, the magnetic clutch pulley of the present invention includes a hollowed housing 30 having belt grooves 31 formed on an outer circumferential surface thereof; and a rotor 32 provided with a disk 33 inserted into the housing 30 to form a space in which a field coil body 36 can be mounted and having a plurality of circular arc slots 34 formed along the same circumference of the disk 33. The disk 33 has a plurality of connecting projections 35 formed at a predetermined interval along the circumference thereof so as to be welded to the housing 30.

In the aforementioned configuration, the magnetic clutch pulley is connected to an engine and a belt, and rotated by bearings inserted into a hollow portion of the rotor 32. When an air conditioner is not operated, the magnetic clutch pulley is rotated while a compressor is not driven. When the air conditioner is operated, a magnetic force is generated due to a current applied to the field coil body 36, and thus the compressor is driven due to the magnetic force compressing a clutch hub provided outside the disk 33 while passing through the circular arc slots 34 formed in the disk 33.

Meanwhile, as shown in FIGS. 3 and 4, when welding the plurality of connecting projections 35 formed on the outer circumferential surface of the disk 33 to the housing 30, it is preferred that the connecting projections 35 are formed to have the same length and formed at a predetermined interval such that the rotor 32 and the housing 30 are positioned on a concentric circle of the disk 33. In the embodiment of the present invention, 6 connecting projections 35 are arranged at the same interval, considering the most appropriate welding strength and welding deformation ratio in welding. Various numbers of connecting projections 35 may be formed.

Preferably, the connecting projection 35 is formed to be slightly longer than the inside diameter of the housing 30 such that a portion of the connecting projection 35 is welded in a thermal insertion form at a circumference of the housing 30. Not a conventional high-priced laser welding method but a general AC 3-phase low frequency welding method is applied to a welding method used in the present invention. In the welding method of the present invention, upper and lower electrode jigs 40 and 41 are provided, and the housing is fixed to the lower electrode jig 41. Then, welding is performed by allowing a current to be flowed through the upper and lower electrode jigs 40 and 41 in the state that the upper electrode jig 40 presses the disk 33 provided to the rotor 32. At this time, a welded portion 37 of the housing 30 is partially melted due to the pressure of the upper electrode jig 40 and heat generated in welding, so that the connecting projection 35 can be welded while being thermally inserted into the housing 30. Since only the 6 connecting projections 35 are welded to the housing 30, the rotation imbalance of the pulley due to conventional welding deformation or the occurrence of unequal beads can be minimized. In addition, a top surface of the disk 33 coupled to the housing 30 due to the welding is cut through a subsequent treatment process. At this time, a portion of the beads generated due to the welding is removed.

Meanwhile, a plurality of circular arc slots 34 formed in the disk 33 is formed on the same circumference of the disk 33 through a piercing process using a conventional press. In the present invention, since the connecting projections 35 are welded to the housing 30, the circular arc slots 34 are further formed between the housing 30 and the disk 33. Accordingly, a sufficient magnetic force can be transmitted although the formation of the circular arc slots 34 is minimized through the piercing process.

As described above, in a method of manufacturing a magnetic clutch pulley by welding a disk having circular arc slots formed therein to a housing according to the present invention, connecting projections are formed along an outer circumferential surface of the disk, and a welding process is performed using an AC 3-phase low frequency welder provided with upper and lower electrode jigs such that the connecting projections are coupled to the housing in a thermal insertion form. Although a welded portion is minimized, welding deformation or the occurrence of unequal beads can be reduced while maintaining the welding strength of the welded portion, so that the rotation balance of the pulley can be maintained. Further, there is an advantage in that the pulley having the same quality as a pulley manufactured through a high-priced welding method such as a conventional laser welding method can be manufactured, so that manufacturing costs of the pulley can be reduced. Furthermore, when forming circular arc slots in the disk, the disk is welded to the housing by the connecting projections, and thus circular arc slots are additionally formed between the housing and the disk. Accordingly, the number of circular arc slots formed through a conventional piercing process can be reduced, so that manufacturing costs can be reduced, and productivity can be enhanced.

While the invention has been shown and described with respect to the preferred embodiments, it will be understood by those skilled in the art that various changes and modifications may be made without departing from the spirit and scope of the invention as defined in the following claims.

1. A magnetic clutch pulley, which includes: a hollowed housing 30 having belt grooves 31 formed on an outer circumferential surface thereof; and a rotor 32 provided with a disk 33 inserted into the housing 30 to form a space in which a field coil body 36 can be mounted and having a plurality of circular arc slots 34 formed along the same circumference of the disk 33, wherein the housing 30 and the rotor 32 are positioned on a concentric circle of the disk 33, and a plurality of connecting projections 35 are formed along a circumference of the disk 33 to be coupled to the housing 30.

2. A magnetic clutch pulley of claim 1, wherein the connecting projections 35 may be welded to the housing 30, and thus circular arc slots 34 may be further formed between the housing 30 and the disk 33.

3. A magnetic clutch pulley of claim 1, wherein in welding the connecting projections 35 to the housing, an AC 3-phase low frequency welder provided with upper and lower electrode jigs 40 and 41 may be used, the housing 30 is fixed to the lower electrode jig 41, and the connecting projections 35 are welded and coupled to the housing 30 in a thermal insertion form by allowing a current to be flowed through the upper and lower electrode jigs 40 and 41 in the state that the upper electrode jig 40 presses the disk 33.
